(19) United States
(12) Patent Application Publication
(10) Pub. No.: US 2026/0095317 A1
(43) Pub. Date: Apr. 2, 2026

(54) SECURE USER REGISTRATION AND DEVICE PROVISIONING FOR TRANSACTION SYSTEM

(71) Applicant: Car IQ Inc., Oakland, CA (US)

(72) Inventors: Ryuji Ishiguro, San Francisco, CA (US); Arun Yadav, Cupertino, CA (US); Sterling Pratz, San Francisco, CA (US)

(21) Appl. No.: 18/904,276

(22) Filed: Oct. 2, 2024

(51) Int. Cl. H04L 9/08

(52) U.S. Cl. CPC H04L 9/088; G06F 21/45; H04L 63/08; H04L 63/0876

(57) ABSTRACT

Aspects of the present disclosure describe secure user registration and device provisioning with respect to transaction systems. Some example embodiments use a Password-Authenticated Exchange (PAKE) protocol to facilitate secure registration of a user identifier (ID) and a password with a transaction account service, and provisioning of a user's client device with a client device provisioning service. Upon completion of the PAKE protocol, two keys can be generated: a session key for encrypting and authenticating communications with the server; and a client key for sharing information among client devices. For some example embodiments, a user registers their user ID and password, and subsequently uses their user ID and a personal identified number (PIN) code to provision a primary client device in association with the user ID. Additionally, for some example embodiments, a secondary client device is provisioned in association with the user ID via a provisioned primary client device.

### TECHNICAL FIELD

The present disclosure relates generally to registration processes more specifically, to secure user registration and secure device provisioning with respect to transaction systems.

### BACKGROUND

In today's interconnected digital landscape, secure user registration and device provisioning have become critical components of many online services and applications. The need for robust security measures has grown exponentially as cyber threats continue to evolve and become more sophisticated.

### BRIEF DESCRIPTION OF THE SEVERAL VIEWS OF THE DRAWINGS

The disclosure will be understood more fully from the detailed description given below and from the accompanying drawings of various example embodiments of the disclosure. The detailed description includes systems, methods, techniques, instruction sequences, or computing machine program products that embody illustrative example embodiments of the disclosure. In the following description, for the purposes of explanation, numerous specific details are set forth in order to provide an understanding of various example embodiments of the inventive subject matter. It will be evident, however, to those skilled in the art, that example embodiments of the inventive subject matter may be practiced without these specific details. In general, well-known instruction instances, protocols, structures, and techniques are not necessarily shown in detail. To easily identify the discussion of any particular element or act, the most significant digit or digits in a reference number refer to the figure number in which that element is first introduced. Some non-limiting examples are illustrated in the figures of the accompanying drawings.

FIG. 1 is a diagrammatic representation of an example transaction system with a registration process in a networked environment in which the present disclosure may be deployed, in accordance with some embodiments of the present disclosure.

FIG. 2 is a block diagram illustrating an example implementation of a transaction system with a registration process, according to various embodiments of the present disclosure.

FIG. 3 through FIG. 5 are flowcharts illustrating example methods for secure user registration and device provisioning, in accordance with some example embodiments of the present disclosure.

FIG. 6 is a diagram illustrating example interactions between one or more servers and client devices, in accordance with some example embodiments of the present disclosure.

FIG. 7 is a diagram illustrating example interactions between one or more servers and client devices, in accordance with some example embodiments of the present disclosure.

FIG. 8 is a diagrammatic representation of a machine in the form of a computer system within which a set of instructions may be executed for causing the machine to perform any one or more of the methodologies discussed herein, in accordance with some example embodiments of the present disclosure.

FIG. 9 is a block diagram showing a software architecture within which examples may be implemented.

### DETAILED DESCRIPTION

The description that follows includes systems, methods, techniques, instruction sequences, and computing machine program products that embody illustrative example embodiments of the disclosure. In the following description, for the purposes of explanation, numerous specific details are set forth in order to provide an understanding of various example embodiments of the inventive subject matter. It will be evident, however, to those skilled in the art, that example embodiments of the inventive subject matter may be practiced without these specific details. In general, well-known instruction instances, protocols, structures, and techniques are not necessarily shown in detail.

Conventional systems often employ a two-step process for onboarding a user to a system (e.g., online system) - initial user registration followed by device provisioning. During user registration, individuals typically create an account by providing a username and password. This process generally involves the generation of cryptographic keys for securing communications between the client and server. Client device provisioning usually focuses on securely associating a computing device (or additional computing devices) with a user's account. This process can involve some form of user authentication to ensure that only authorized computing devices are associated (e.g., added) to the account.

The current state of the art in user registration and device provisioning aims to balance security, usability, and scalability. However, as threats continue to evolve, there is an ongoing need for innovative approaches that can enhance security without compromising the user experience or system performance. Ensuring secure communication between clients and servers, while maintaining the confidentiality and integrity of user credentials, remains a concern. Traditional methods often rely on simple password-based authentication, which can be vulnerable to various attacks, including brute force, phishing, and man-in-the-middle attacks. As the number of connected devices increases, the complexity of managing secure registrations and provisioning processes also escalates. Existing solutions for user registration and device provisioning exhibit several shortcomings. Many rely on centralized systems that store user credentials, making them attractive targets for attackers. Additionally, these systems often lack robust mechanisms for securely sharing information among multiple devices, leading to potential security breaches. The absence of a secure method for generating and managing session identifiers and client identifiers further exacerbates the risk of unauthorized access and data compromise. Furthermore, the manual input process for registering new devices can be cumbersome and error-prone, reducing overall system efficiency and user experience.

Various embodiments of the present disclosure provide for secure user registration and secure client device provisioning. Some example embodiments enable secure user registration by a transaction account service (e.g., operating on a transaction account server) and secure client device provisioning (in association with a registered user) by a client device provisioning service (e.g., operating on a device provisioning server). As used herein, a transaction account service of a transaction system described herein can enable or support registration of users, user accounts, and electronic financial transactions processing in association with a user. A device provisioning service of a transaction system described herein can enable or support provisioning (e.g., adding) of a client device to a transaction system in association with a user, which can enable the client device to submit one or more electronic financial transactions to the transaction system for processing in association with the user. According to various example embodiments, a Password-Authenticated Key Exchange (PAKE) protocol, such as PAKE with Oblivious PRF (e.g., OPAQUE Asymmetric PAKE Protocol), is used to facilitate secure registration of a user ID and a password with the transaction account service, and provisioning of a user's client device with the client device provisioning service. Upon completion of the PAKE protocol, two keys can be generated: a session key (SK) for encrypting and authenticating communications with the server; and a client key (CK) for sharing information among client devices. For some example embodiments, a user registers their user ID and password using a PAKE protocol, and subsequently uses their user ID and a personal identified number (PIN) code to provision (e.g., add) a primary client device (or a primary device) in association with the user ID. Additionally, for some example embodiments, a secondary client device (hereafter the secondary device) is provisioned (e.g., added) in association with the user ID via a provisioned primary client device.

Various example embodiments described herein provide a technical solution for, and technical improvement to, secure and scalable user registration and multi-device provisioning, which can maintain end-to-end encryption and user privacy throughout the process. Various example embodiments can use a PAKE protocol to securely register user IDs and passwords, and generate session data and client data to ensure encrypted and authenticated communication. The client data, retained by the client, can facilitate secure information sharing among client devices. Use of various example embodiments can also streamline the registration of primary and secondary devices, utilizing encrypted configuration data to automate the provisioning process. By leveraging these techniques, various example embodiments can enhance security, reduce the risk of unauthorized access, and simplify the management of multiple devices within a network.

As used herein, a PAKE protocol can refer to a protocol used by entities/parties within a computing environment to establish shared cryptographic keys based on their same knowledge of a password. Generally, a PAKE protocol can allow a client device and a server to establish a shared cryptographic key based on a user's password without requiring the server to store the password itself.

As used herein, a transaction system can refer to a system configured to facilitate, manage, or secure financial transactions. An example transaction system can integrate various components such as sensors, processors, and software algorithms, to autonomously handle electronic financial payments and other electronic financial activities. The transaction system can streamline the process of financial exchanges, ensuring accuracy, security, and efficiency without requiring direct human intervention. An example of a transaction system can include an automated financial transaction system integrated, which can be used with vehicles. Such a transaction system can use in-car sensors, including cameras and GPS units, to detect toll fees, parking fees, and other charges. The transaction system can, for example, employ machine learning algorithms to support object recognition and reduce false positives during toll detection. The transaction system can feature an in-machine wallet that autonomously handles payments based on data from the sensors. Additionally, the transaction system can manage feature subscriptions, traffic violation fines, and maintain detailed records of vehicle usage, repairs, and charging histories. All transactions and associated data can be securely recorded in a confidential ledger, often utilizing blockchain technology, to ensure data integrity and privacy. Various embodiments described herein can facilitate secure user registration, secure device provisioning, or both with respect to a transaction system.

As used herein, provisioning can refer to an operation that adds an association between a device (e.g., client device) and a registered user of a system (e.g., transaction system). During provisioning of a device in association with a registered user of a system (e.g., transaction system), the system can be prepared (e.g., hardware or software configured) to permit the system to provide one or more services (e.g., electronic transaction services) to the device in association with the registered user, and the device can be prepared (e.g., hardware or software configured) to interact with the system and make use of the one or more services in association with the registered user.

Reference will now be made in detail to various example embodiments of the present disclosure, examples of which are illustrated in the appended drawings. The present disclosure may, however, be embodied in many different forms and should not be construed as being limited to the examples set forth herein.

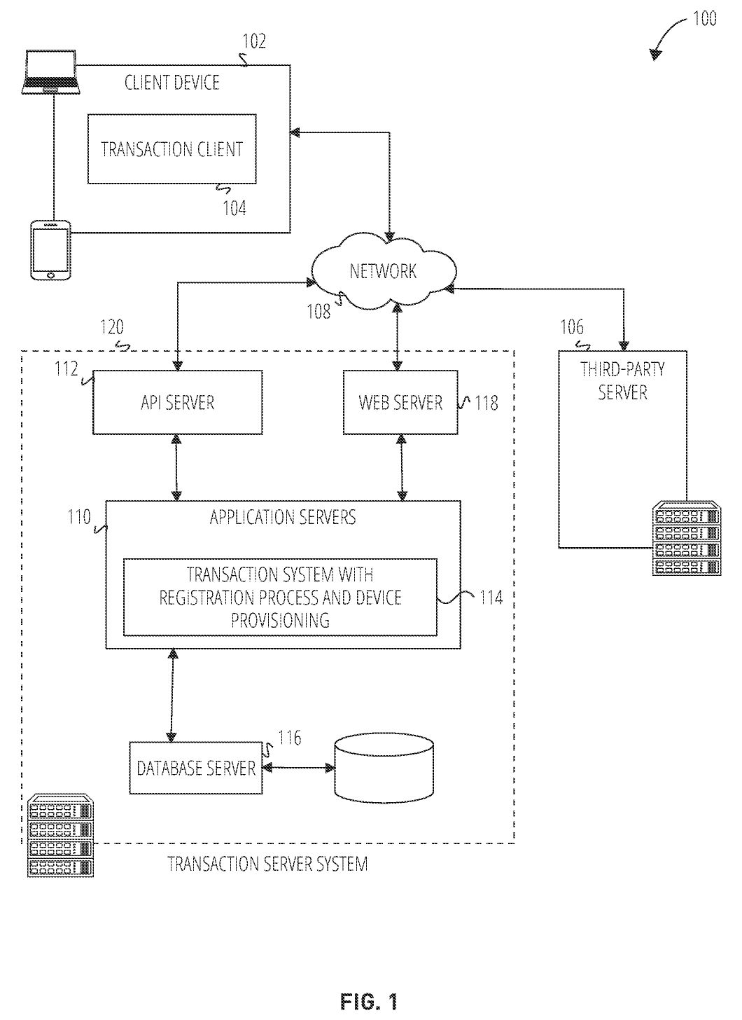

FIG. 1 is a diagrammatic representation of an example transaction system 114 with a registration process in a networked environment 100 in which the present disclosure may be deployed, in accordance with some embodiments. Though not shown, the transaction system 114 can include multiple instances of a client device 102 and multiple instances of a third-party server 106.

The client device 102 is associated with a user (e.g., transaction account user) of the transaction system 114. Examples of client devices include, without limitation, personal computers (e.g., desktop, laptops, etc.), mobile devices (e.g., smartphones), and in-vehicle computing devices (e.g., embedded computer system of a motor vehicle). A user (e.g., transaction account user) associated with the client device 102 can be an owner of the client device or operator of the client device. For instance, the client device can be an in-vehicle computing device of a vehicle owned or operated by the user.

Each of the client devices 102 hosts a number of applications, including a transaction client 104. Each transaction client 104 is communicatively coupled with a transaction server system 120 and third-party servers 106 via a network 108 (e.g., communication network or the Internet). A transaction client 104 can also communicate with locally-hosted applications using Applications Program Interfaces (APIs). The client devices 102 can also host a number of applications including Internet browsing applications (e.g., Chrome, Safari, etc.). The transaction client 104 can also be implemented as a platform that is accessed by the client device 102 via an Internet browsing application or implemented as an extension on the Internet browsing application.

A transaction client 104 is able to communicate and exchange data with the transaction server system 120 via the network 108. The data exchanged between the transaction client 104 and the transaction server system 120, includes functions (e.g., commands to invoke functions) as well as payload data (e.g., user identifiers, passwords, session keys, client keys, configuration data, electronic transaction requests, etc.).

The transaction server system 120 can also communicate and exchange data with third-party server 106 to obtain further data and information on users, accounts, and transactions. The third-party server 106 can be servers hosting different websites or online services comprising this data and information.

The transaction server system 120 supports various services and operations that are provided to the transaction client 104. Such operations include access to the functionalities of the systems in transaction server system 120. Data exchanges to and from the transaction server system 120 ca be invoked and controlled through functions available to a user at the client device 102 via user interfaces (UIs) of the transaction client 104.

The transaction server system 120 provides server-side functionality via the network 108 to a particular transaction client 104. While certain functions of the transaction system 114 are described herein as being performed by either a transaction client 104 or by the transaction server system 120, the location of certain functionality either within the transaction client 104 or the transaction server system 120 may be a design choice. For example, it may be technically preferable to initially deploy certain technology and functionality within the transaction server system 120 but to later migrate this technology and functionality to the transaction client 104 where a client device 102 has sufficient processing capacity.

Turning now specifically to the transaction server system 120, an Application Program Interface (API) server 112 is coupled to, and provides a programmatic interface to, application servers 110. The application servers 110 are communicatively coupled to a database server 116, which facilitates access to a database that stores data from the third-party server 106 and client device 102 to be processed by the application servers 110. Similarly, a web server 118 is coupled to the application servers 110, and provides web-based interfaces to the application servers 110. To this end, the web server 118 processes incoming network requests over the Hypertext Transfer Protocol (HTTP) and several other related protocols.

The Application Program Interface (API) server 112 receives and transmits data between the client device 102 and the application servers 110. Specifically, the Application Program Interface (API) server 112 provides a set of interfaces (e.g., routines and protocols) that can be called or queried by the transaction client 104 in order to invoke functionality of the application servers 110. The Application Program Interface (API) server 112 exposes to the transaction client 104 various functions supported by the application servers 110, including generating session keys, client keys, and processing transaction requests.

The application servers 110 host a number of server applications and subsystems, including for example a transaction system 114. The transaction system 114 implements a number of data processing technologies and functions, particularly related to secure user registration and secure device provisioning (in association with a registered user). Other processor and memory intensive processing of data may also be performed server-side by the transaction system 114, in view of the hardware requirements for such processing.

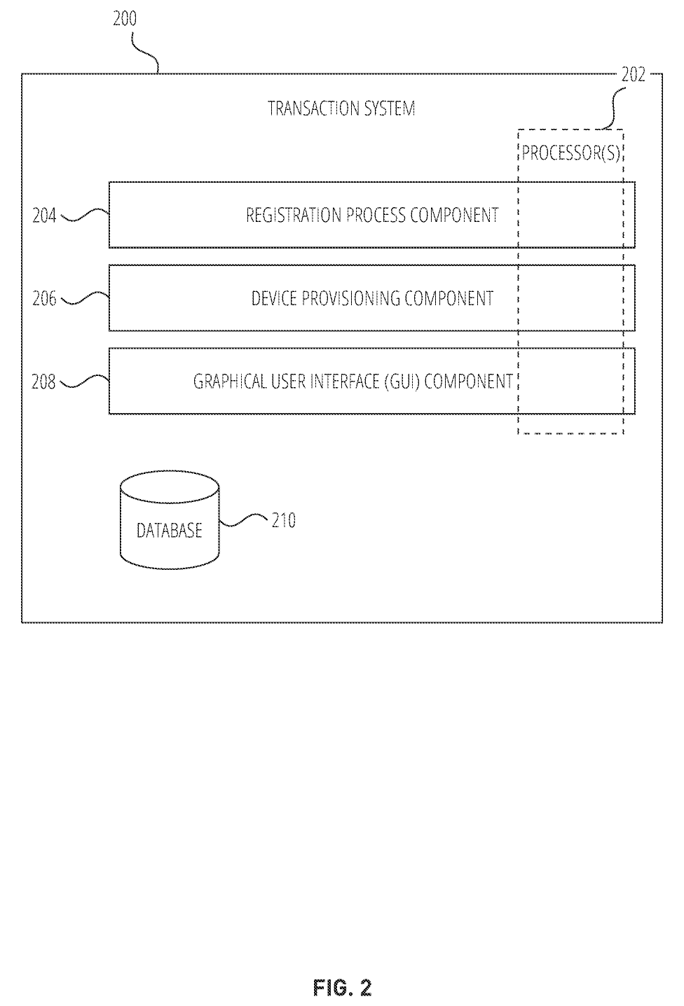

FIG. 2 is a block diagram illustrating an example implementation of a transaction system 200, according to various embodiments of the present disclosure. For some embodiments, the anomaly detection system 200 represents an example of the transaction system 114 described with respect to FIG. 1. As shown, the transaction system 200 comprises a registration process component 204, a device provisioning component 206, and a graphical user interface component 208. According to various embodiments, one or more of the registration process component 204, the device provisioning component 206, and the graphical user interface component 208 are implemented by one or more processors 202. Data generated by, or used by, one or more of the registration process component 204, the device provisioning component 206, and the graphical user interface component 208 is stored on a database (or datastore) 210 of the transaction system 200.

The registration process component 204 is configured to facilitate registration of a user (e.g., transaction account user) with the transaction system 200. The device provisioning component 206 is configured to facilitate provisioning (e.g., adding) of one or more client devices in association with a user (e.g., transaction account user) registered with the transaction system 200. The graphical user interface component 208 is configured to enable a user at a client device to access and use one or more features of the registration process component 204, the device provisioning component 206, or both.

Although the described flowcharts can show operations as a sequential process, many of the operations can be performed in parallel or concurrently. In addition, the order of the operations may be re-arranged. A process is terminated when its operations are completed. A process may correspond to a method, a procedure, an algorithm, etc. The operations of methods may be performed in whole or in part, may be performed in conjunction with some or all of the operations in other methods, and may be performed by any number of different systems, such as the systems described herein, or any portion thereof, such as a processor included in any of the systems.

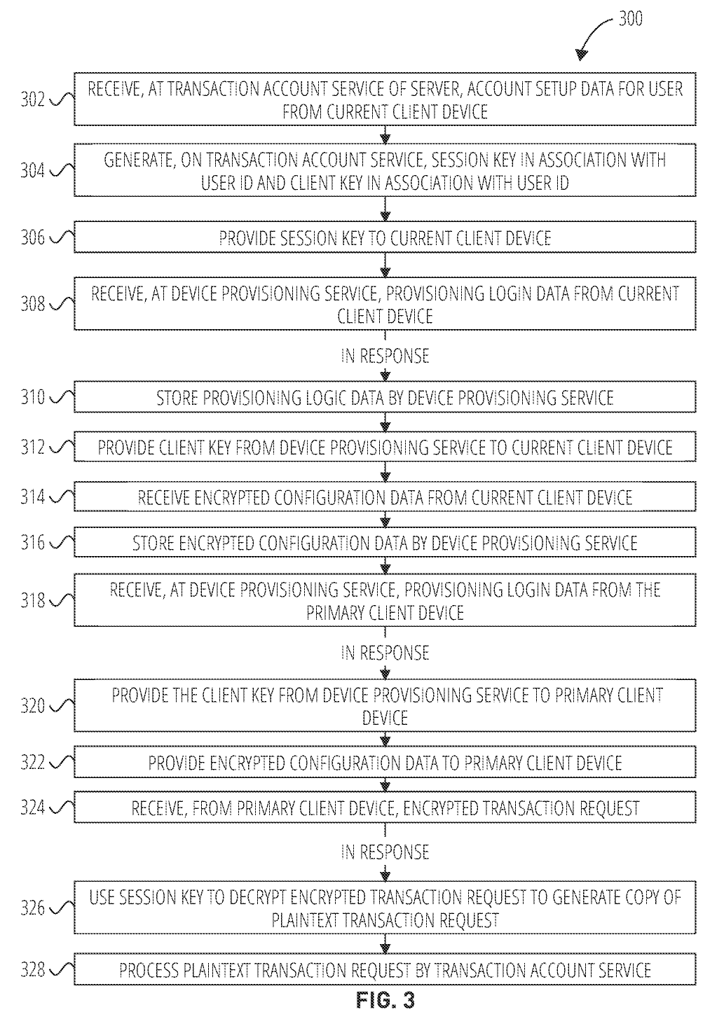

FIG. 3 through FIG. 5 are flowcharts illustrating example methods 300, 400, 500 for secure user registration and device provisioning, in accordance with some example embodiments of the present disclosure. For explanatory purposes, methods 300, 400, 500 are primarily described herein with reference to the transaction system 114 of FIG. 1, and the client device 102 of FIG. 1. However, one or more operations of any of methods 300, 400, 500 may be performed by one or more other components, or by other suitable devices. Further for explanatory purposes, the operations of any of methods 300, 400, 500 are described herein as occurring in serial, or linearly. However, multiple operations of any of methods 300, 400, 500 may occur in parallel or concurrently. In addition, the operations of any of methods 300, 400, 500 need not be performed in the order shown or one or more operations of any of methods 300, 400, 500 need not be performed or can be replaced by other operations. Any of methods 300, 400, 500 may be terminated when its operations are completed. In addition, any of methods 300, 400, 500 may correspond to a process, a procedure, an algorithm, etc. For some example embodiments, a transaction system that performs any of methods 300, 400, 500 comprises a transaction account service, a device provisioning service, or both. The transaction account service and the device provisioning service can be operated on a single set of servers (e.g., that implement transaction system 114) or can be operated on separate sets of servers (e.g., that implement transaction system 114).

Referring now to method 300 of FIG. 3, operations 302 through 316 represent example operations performed by a system (e.g., the transaction system 114) to securely register a user with the system, where the user uses a current client device (e.g., client device 102) to facilitate the user's registration. At operation 302, a processor of a system (e.g., implementing a transaction account service of the transaction system 114) receives account setup data for a user from a current client device. For some example embodiments, the account setup data comprises a user identifier (ID) for the user and a password for the user. Upon receiving (e.g., a transaction account service of the transaction system 114) the user ID and the password, the processor can generate a (new) user account for the user with the user ID and the password, thereby registering the user.

As part of the user's registration process, during operation 304, the processor of the system (e.g., implementing the transaction account service of the transaction system 114) generates a session key in association with the user ID and a client key in association with the user ID. For various example embodiments, the session key is meant to be used to encrypt and authenticate one or more messages between one or more client devices associated with the user and the system, and the client key is meant to be used (e.g., exclusively) by the one or more client devices (associated with the user and the system) for sharing information with the system. A PAKE protocol can be used to generate the session key on the system and the client key on the current client device. For some example embodiments, the session key is generated and stored on the transaction account service in association with the user ID, and the client key is generated and stored on the device provisioning service in association with the user ID. As also part of the user's registration process, at operation 306, the processor of the system (e.g., implementing the device provisioning service of the transaction system 114) provides the session key to the current client device (e.g., client device 102).

For operation 308, the processor of the system (e.g., implementing a device provisioning service of the transaction system 114) receives provisioning login data from the current client device (e.g., client device 102). For some example embodiments, the provisioning login data comprises the user ID and a personal identification number (PIN) code from the current client device. Upon receiving the provisioning login data, at operation 310, the processor of the system (e.g., device provisioning service) stores the provisioning logic data to enable subsequent authentication and provisioning of primary and secondary client devices in association with the user (e.g., user ID) on the system (e.g., the transaction system 114).

In response to receiving the provisioning login data, at operation 312, the processor of the system (e.g., implementing the device provisioning service of the transaction system 114) provides the client key from the processor (e.g., the device provisioning service) to the current client device (e.g., client device 102). Subsequently, at operation 314, the processor of the system (e.g., implementing the device provisioning service of the transaction system 114) receives encrypted configuration data from the current client device (e.g., client device 102). According to various example embodiments, the current client device is configured to generate the encrypted configuration data by encrypting plaintext configuration data using the client key provided to the current client device by the processor (e.g., provided by the device provisioning service). Depending on the example embodiment, the plaintext configuration data can comprise at least one of the user ID, the session key (e.g., provided by the transaction account service), or profile information of the user (e.g., the user's real name, e-mail address, residential address, phone number, etc.). Upon receiving the encrypted configuration data, at operation 316, the processor of the system stores the encrypted configuration data by the processor (e.g., the device provisioning service of the transaction system 114). Once stored by the processor, the processor (e.g., the device provisioning service of the transaction system 114) can use the stored encrypted configuration data for subsequent provisioning of primary and secondary client devices in association with the user (e.g., the user's user ID).

Operations 318 through 322 represent example operations performed by the system (e.g., the transaction system 114) that enables the user to provision (e.g., add) a primary client device on the system (e.g., the transaction system 114) in association with the user (e.g., in association with the user's user ID). Depending on the example embodiment, the primary client device can be different from, or the same as, the client device used by the user to register with the system (e.g., via the transaction account service of the transaction system 114).

At operation 318, the processor of the system (e.g., implementing the device provisioning service of the transaction system 114) receives, at the processor, provisioning login data from a primary client device. For various example embodiments, the provisioning login data is the same as the provisioning login data the processor (e.g., the device provisioning service) receives from the user (at operation 308) and stored (at operation 310) during the user registration process. Accordingly, the provisioning login data from the primary client device can comprise the user ID and the PIN code. The provisioning login data received from the primary client device can facilitate the authentication and provisioning of the primary client device in association with the user on the system (e.g., the transaction system 114).

In response to receiving the provisioning login data from the primary client device, at operation 320, the processor of the system (e.g., implementing the device provisioning service of the transaction system 114) provides the client key from the processor to the primary client device. Additionally, at operation 322, the processor of the system (e.g., implementing the device provisioning service) provides encrypted configuration data to the primary client device. For various example embodiments, the encrypted configuration data provided to the primary client device is the same encrypted configuration data that was received (at operation 314) and stored (at operation 316) by the processor (e.g., the device provisioning service). According to various example embodiments, the primary client device is configured to use the client key (provided to the primary client device at operation 320) to decrypt the encrypted configuration data to generate a copy of the plaintext configuration data on the primary client device. For some example embodiments, the user can provision (e.g., add) two or more primary client devices on the system (e.g., the transaction system 114) in association with the user's user ID.

Operations 324 through 328 represent example operations performed by the system (e.g., the transaction system 114) that enables a provisioned primary client device (e.g., one already provisioned with the system via operations 318 through operation 322) to transmit a transaction to the system (e.g., the transaction system 114) in association with the user. According to various example embodiments, the transaction requested by the primary client device is an electronic financial transaction, such as one relating to a vehicle (e.g., toll fees, parking fees, and other vehicle-related fees).

At operation 324, the processor of the system (e.g., implementing the transaction account service of the transaction system 114) receives, from the primary client device, an encrypted transaction request. For various example embodiments, the primary client device is configured to generate the encrypted transaction request by encrypting a plaintext transaction request using the session key retrieved by the primary client device from the copy of the plaintext configuration data on the primary client device. According to various example embodiments, the plaintext transaction request comprises information regarding a transaction requested for the user by the primary client device. For instance, the plaintext transaction request can comprise information specifying the amount of the electronic financial transaction, the time (e.g., timestamp) of when the request was generated, where the primary client device was when the request was generated, or the item (e.g., product, service, or fee) associated with the transaction.

In response to receiving the encrypted transaction request, at operation 326, the processor of the system (e.g., implementing the transaction account service of the transaction system 114) uses the session key (generated during operation 304) to decrypt the encrypted transaction request to generate a copy of the plaintext transaction request on the system (e.g., the transaction system 114). Subsequently, at operation 328, the processor of the system (e.g., the transaction account service) processes the copy of the plaintext transaction request (e.g., according to the information contained therein) in association with the user (e.g., user ID).

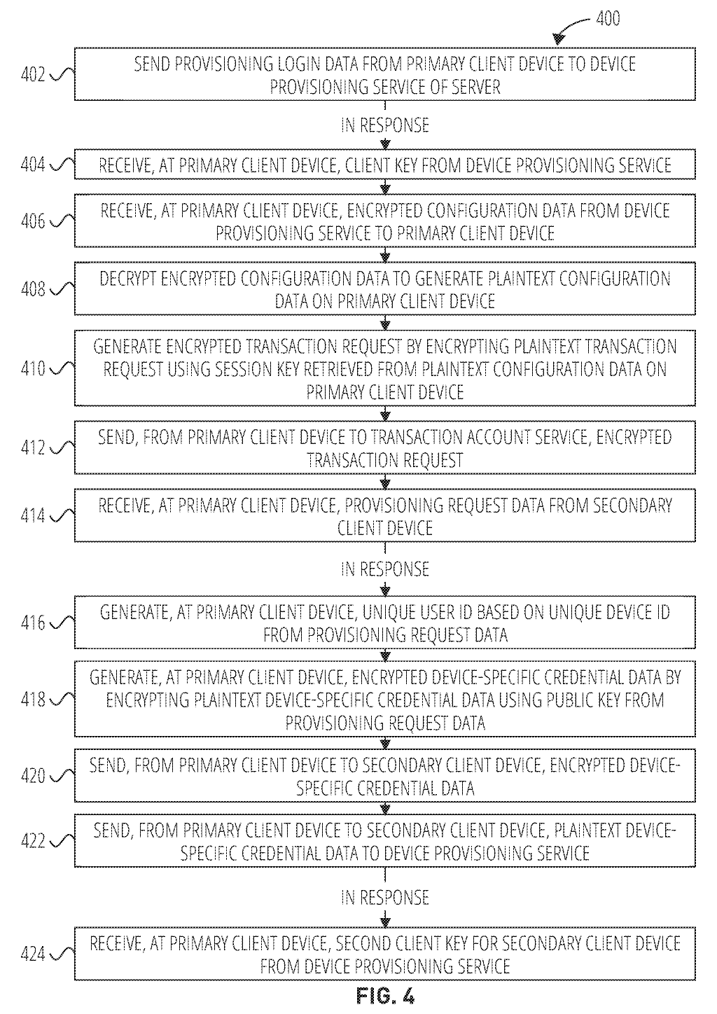

Referring now to FIG. 4, operations 402 through 408 of method 400 represent example operations performed by a primary client device to provision (e.g., add) itself on a system (e.g., the transaction system 114) in association with a user (e.g., user ID) of the system (e.g., the transaction system 114). For various example embodiments, the primary client device is a client device (e.g., client device 102). For instance, the primary client device can comprise a user's smartphone.

At operation 402, a processor of the primary client device sends provisioning login data from the primary client device to a device provisioning service of a server (e.g., implementing at least a portion of the transaction system 114). For various example embodiments, the provisioning login data comprises a user ID of a user and a PIN code. According to various example embodiments, the user ID and the PIN code are the same as the user ID and the PIN code provided by the user to the system (e.g., the device provisioning service of the transaction system 114) during the user registration process (e.g., facilitated by method 300 of FIG. 3). As described herein, the provisioning login data sent from the primary client device to the device provisioning service can facilitate the authentication and provisioning of the primary client device in association with the user on the system (e.g., the transaction system 114).

In response to sending the provisioning login data to the device provisioning service, at operation 404, the processor of the primary client device receives a client key from the device provisioning service. According to various example embodiments, the client key is associated with the user (e.g., the user ID) and generated by the system (e.g., by a transaction account service of the transaction system 114) during the user registration process (e.g., facilitated by method 300 of FIG. 3). Additionally, at operation 406, the processor of the primary client device receives encrypted configuration data from the device provisioning service. For various example embodiments, the encrypted configuration data received by the primary client device is the same encrypted configuration data that was received (e.g., at operation 314 of method 300 of FIG. 3) and stored (e.g., at operation 316 of method 300 of FIG. 3) by the device provisioning service during the user registration process (e.g., facilitated by method 300 of FIG. 3).

During operation 408, the processor of the primary client device decrypts the encrypted configuration data to generate plaintext configuration data on the primary client device. For various example embodiments, the plaintext configuration data comprises at least one of the user ID, a session key in association with the user ID, or profile information of the user. According to some example embodiments, after operation 408, the primary client device can be considered provisioned with the system (e.g., the transaction system 114) and ready to submit electronic transaction requests in association with the user.

Operations 410 and 412 represent example operations performed by a provisioned primary client device (e.g., one already provisioned on the system via operations 402 through 408) to transmit a transaction to the system (e.g., the transaction system 114) in association with the user. At operation 410, the processor of the primary client device generates encrypted transaction request by encrypting a plaintext transaction request using the session key retrieved from the plaintext configuration data on the primary client device (generated at operation 408). According to various example embodiments, the plaintext transaction request comprises information regarding a transaction requested for the user by the primary client device. For instance, the plaintext transaction request can comprise information specifying the amount of the electronic financial transaction, the time (e.g., timestamp) of when the request was generated, where the primary client device was when the request was generated, or the item (e.g., product, service, or fee) associated with the transaction.

At operation 412, the processor of the primary client device sends the encrypted transaction request to a transaction account service of the server (e.g., implementing the transaction system 114). According to various example embodiments, a processor implementing the transaction account service is configured to receive the encrypted transaction request, decrypt the encrypted transaction request to generate a copy of the plaintext transaction request on the transaction account service, and process the copy of the plaintext transaction request (e.g., according to the information contained therein) in association with the user (e.g., user ID).

Operations 414 through operation 424 represent example operations performed by a provisioned primary client device (e.g., one already provisioned on the system via operations 402 through 408) to facilitate provisioning of a secondary client device in association with the user (e.g., user ID). At operation 414, the processor of the primary client device receives provisioning request data from a secondary client device. For various example embodiments, the provisioning request data comprises a public key from an ephemeral key pair generated on the secondary client device. Additionally, for some example embodiments, the provisioning request data comprises at least one of a unique device identifier (ID) of the secondary client device or attribute information associated with the secondary client device. For example, where the secondary client device is associated with (e.g., part of) a vehicle (e.g., car or truck), the attribute information can comprise at least one of a vehicle identification number (VIN), a make of the vehicle, or a model of the vehicle.

In response to receiving the provisioning request data from the secondary client device, at operation 416, the processor of the primary client device generates a unique user identifier (ID) for the secondary client device based on the unique device ID received in the provisioning request data by the primary client device (at operation 414). Additionally, at operation 418, the processor of the primary client device generates encrypted device-specific credential data by encrypting plaintext device-specific credential data using the public key from the provisioning request data. For various example embodiments, the plaintext device-specific credential data comprises the unique user ID for the secondary client device and a PIN code. For various example embodiments, the PIN code is the same PIN code provided by the user to the device provisioning service during user registration (e.g., facilitated by method 300 of FIG. 3). Subsequently, at operation 420, the processor of the primary client device sends the encrypted device-specific credential data to the secondary client device.

At operation 422, the processor of the primary client device sends the plaintext device-specific credential data to the device provisioning service. In response to sending the plaintext device-specific credential data to the device provisioning service, at operation 424, the processor of the primary client device receives, from the device provisioning service, a client key for the secondary client device. For various example embodiments, the client key for the secondary client device is different from the client key for the primary client device (e.g., the client key for the secondary client device is exclusively associated with the secondary client device).

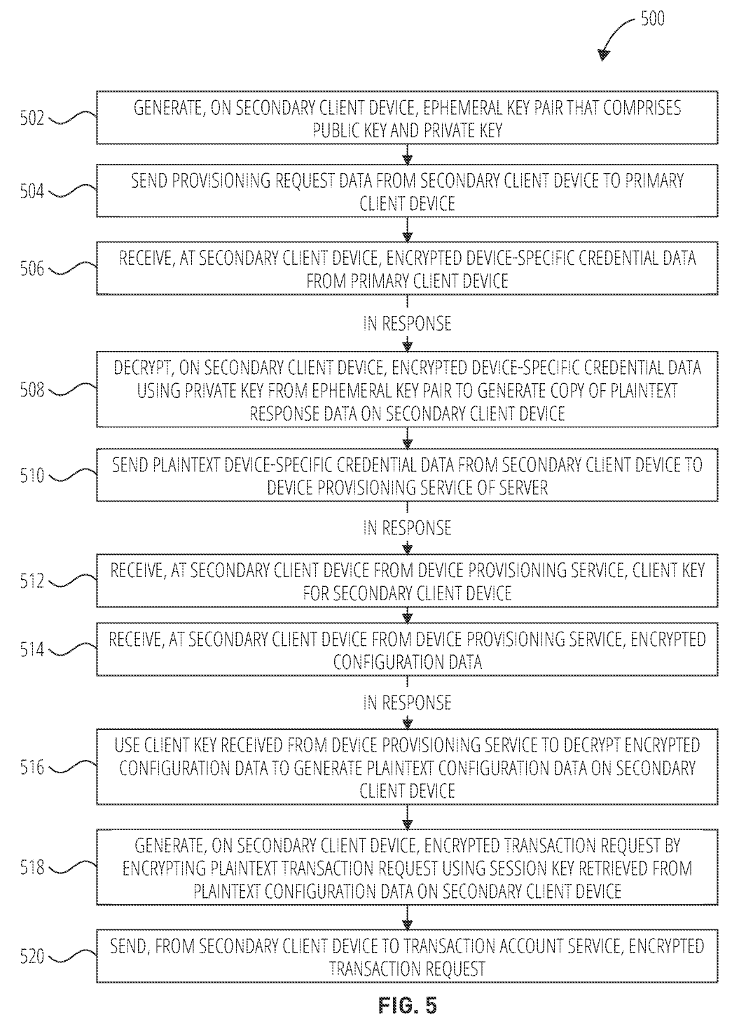

Referring now to FIG. 5, operations 502 through 516 of method 500 represent example operations performed by a secondary client device to provision itself on a system (e.g., the transaction system 114) in association with a user (e.g., user ID) of the system (e.g., the transaction system 114) using a provisioned primary client device (e.g., one already provisioned with the system via operations 318 through operation 322 of method 300 of FIG. 3). For various example embodiments, the primary client device is a client device (e.g., client device 102) already provisioned in association with the user (e.g., via operations 318 through 322 of method 300 of FIG. 3), and the secondary client device is another client device (e.g., one similar to the client device 102) separate from the primary client device. For instance, the primary client device can comprise a user's smartphone and the secondary client device can comprise an in-vehicle computing device (e.g., implementing an in-vehicle computer system).

At operation 502, a processor of a secondary client device generates, on the secondary client device, an ephemeral key pair that comprises a public key and a private key. Then, at operation 504, the processor of the secondary client device sends provisioning request data from the secondary client device to the primary client device. For various example embodiments, the provisioning request data comprises the public key from the ephemeral key pair generated at operation 502. Additionally, for various example embodiments, the provisioning request data comprises at least one of a unique device identifier (ID) of the secondary client device or attribute information associated with the secondary client device. For example, where the secondary client device is associated with (e.g., part of) a vehicle (e.g., car or truck), the attribute information can comprise at least one of a vehicle identification number (VIN), a make of the vehicle, or a model of the vehicle.

During operation 506, the processor of a secondary client device receives encrypted device-specific credential data from the primary client device. According to various example embodiments, the primary client device is configured to generate the encrypted device-specific credential data by encrypting plaintext device-specific credential data using the public key (of the ephemeral key pair) provided to the primary client device by the secondary client device as part of the provisioning request data sent during operation 504. For some example embodiments, the plaintext device-specific credential data comprises a unique user ID for the secondary client device and a PIN code. For some example embodiments, the unique user ID (included in the plaintext device-specific credential data) is generated by the primary client device based on the unique device ID received by the primary client device from the secondary client device (during operation 504). The PIN code can be the same PIN code provided by the user to the device provisioning service during user registration (e.g., facilitated by method 300 of FIG. 3).

In response to receiving the encrypted device-specific credential data, at operation 508, the processor of the secondary client device decrypts the encrypted device-specific credential data using the private key from the ephemeral key pair to generate a copy of the plaintextdevice-specific credential data on the secondary client device. Subsequently, at operation 510, the processor of the secondary client device sends the plaintext device-specific credential data to a device provisioning service of a server (e.g., implementing at least a portion of the transaction system 114). In response to sending the plaintext device-specific credential data to the device provisioning service, at operation 512, the processor of the secondary client device receives a client key for the secondary client device from the device provisioning service. For various example embodiments, the client key for the secondary client device is different from the client key for the primary client device (e.g., the client key for the secondary client device is exclusively associated with the secondary client device). Additionally, in response to sending the plaintext device-specific credential data to the device provisioning service, at operation 514, the processor of the secondary client device receives the encrypted configuration data from the device provisioning service. For various example embodiments, the encrypted configuration data received by the secondary client device is the same encrypted configuration data that was received (e.g., at operation 314 of method 300 of FIG. 3) and stored (e.g., at operation 316 of method 300 of FIG. 3) by the device provisioning service during the user registration process (e.g., facilitated by method 300 of FIG. 3).

In response to receiving the encrypted configuration data from the device provisioning service, at operation 516, the processor of the secondary client device uses the client key received from the device provisioning service to decrypt the encrypted configuration data to generate plaintext configuration data on the secondary client device. For various example embodiments, the plaintext configuration data comprises at least one of the user ID, a session key in association with the user ID, or profile information of the user. According to some example embodiments, after operation 516, the secondary client device can be considered provisioned with the system (e.g., the transaction system 114) and ready to submit electronic transaction requests in association with the user. For some example embodiments, the user can provision (e.g., add) two or more secondary client devices on the system (e.g., the transaction system 114) in association with the user's user ID.

Operations 518 and 520 represent example operations performed by a provisioned secondary client device (e.g., one already provisioned on the system via operations 502 through 516) to transmit a transaction to the system (e.g., the transaction system 114) in association with the user. At operation 518, the processor of the secondary client device generates encrypted transaction request by encrypting a plaintext transaction request using the session key retrieved from the plaintext configuration data on the secondary client device (generated at operation 516). According to various example embodiments, the plaintext transaction request comprises information regarding a transaction requested for the user by the secondary client device. For instance, the plaintext transaction request can comprise information specifying the amount of the electronic financial transaction, the time (e.g., timestamp) of when the request was generated, where the secondary client device was when the request was generated, or the item (e.g., product, service, or fee) associated with the transaction.

Subsequently, at operation 520, the processor of the secondary client device sends the encrypted transaction request to a transaction account service of the server (e.g., implementing the transaction system 114). According to various example embodiments, a processor implementing the transaction account service is configured to receive the encrypted transaction request, decrypt the encrypted transaction request to generate a copy of the plaintext transaction request on the transaction account service, and process the copy of the plaintext transaction request (e.g., according to the information contained therein) in association with the user (e.g., user ID).

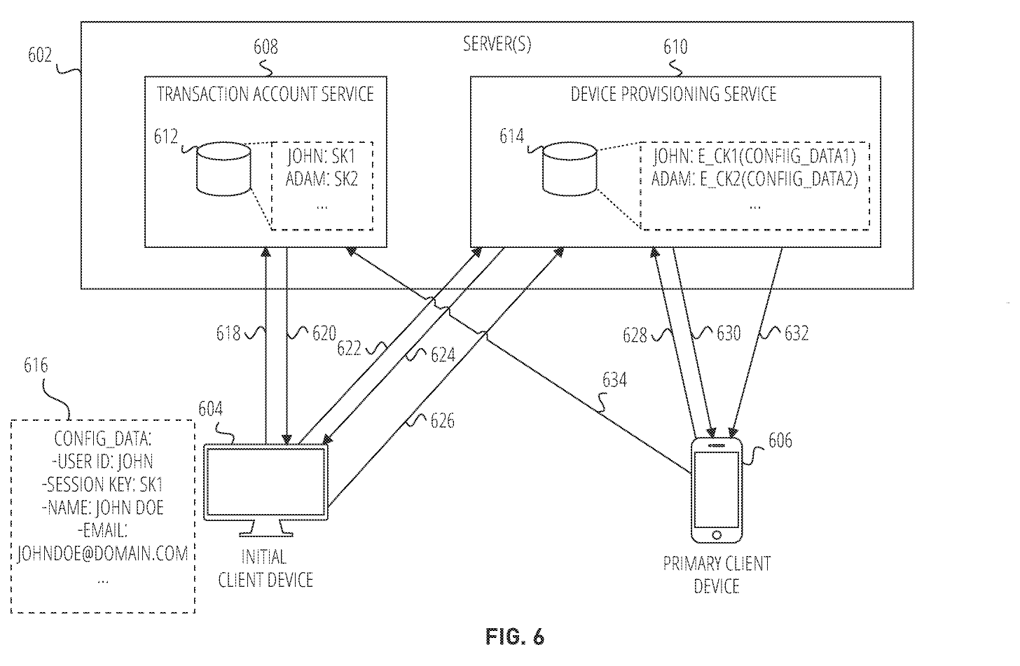

FIG. 6 is a diagram illustrating example interactions between one or more servers 602 of a system (e.g., the transaction system 114), an initial client device 604 used by a user to facilitate user registration on the system, and a primary client device 606 during user registration and provisioning of the primary client device 606, in accordance with some example embodiments of the present disclosure. As shown, the one or more servers 602 comprises a transaction account service 608 and a device provisioning service 610. For various example embodiments, the transaction account service 608 enables or supports registration of users, user accounts, and electronic financial transaction processing in association with a user. For some example embodiments, the device provisioning service 610 enables or supports provisioning (e.g., adding) of a client device (e.g., the primary client device 606) to a transaction system in association with a user, which can enable the client device to submit one or more electronic financial transactions to the transaction system for processing in association with the user.

During a user registration process, a user at the initial client device 604 initiates a user sign-up process, where the user registers a user ID (e.g., “JOHN”) for their (new) user account (e.g., user transaction account) and a password for their user account (618) with the transaction account service 608. The sign-up process can use a PAKE protocol, can result in a session key (SK1) being generated on the transaction account service 608 in association with the user ID (which is stored on transaction account data store 612, for example as “JOHN:SK1”), and can result in a first client key (CK1) being generated in association with the user ID on the device provisioning service 610. The session key can be used for encrypting and authenticating communications between the one or more servers 602 and client devices associated with the user ID, and the first client key can be associated with a particular client device and used for sharing information with the one or more servers 602 or other client devices associated with the user ID. For example, the session key can be used by client devices for making electronic transaction requests (e.g., “cash-in,” “pay”) and decrypting responses sent to client devices by the one or more servers 602. Upon registering the user ID and the password with the transaction account service 608, the user can be considered to be registered on the system (e.g., the transaction system 114). As part of the user sign-up process, the transaction account service 608 eventually provides the initial client device 604 with the session key (SK1) (620).

Subsequently, the initial client device 604 registers the user ID (e.g., “JOHN”) and a PIN code (e.g., “1234”) (622) with the device provisioning service 610, and the device provisioning service 610 provides the first client key (CK1) (624) to the initial client device 604 in response. The initial client device 604 generates plaintext configuration data 616 (e.g., config_data) that comprises, without limitation, the user ID (e.g., “JOHN”), the session key (e.g., SK1), a name of the user (e.g., “JOHN DOE”), and an e-mail address (e.g., “JOHNDOE@DOMAIN.COM”), and a phone number. The initial client device 604 encrypts the plaintext configuration data 616 using the first client key (e.g., E_CK1(config_data)) to generate encrypted configuration data, and sends (e.g., uploads) the encrypted configuration data (626) to the device provisioning service 610. The device provisioning service 610 stores the encrypted configuration data (e.g., E_CK1(config_data)) in association with the user ID (e.g., “JOHN”) on a device provisioning data store 614 (e.g., as “JOHN: E_CK1(config_data)”).

To facilitate provisioning (e.g., adding) of the primary client device 606 on the system, the primary client device 606 sends (628) the same user ID (e.g., “JOHN”) and PIN code (e.g., “1234”) (that was registered with the device provisioning service 610 by the initial client device 604) to the device provisioning service 610 in order to log into (e.g., sign in to) the device provisioning service 610 and to receive the first client key (CK1) (630) from the device provisioning service 610. Additionally, the device provisioning service 610 provides (632) the primary client device 606 with a copy of the encrypted configuration data (e.g., E_CK1(config_data)) that is stored on the device provisioning data store 614 in association with the user ID (e.g., “JOHN”) and that was sent (e.g., uploaded) by the initial client device 604 to the initial client device 604 during the user registration process. The primary client device 606 decrypts the encrypted configuration data (e.g., E_CK1(config_data)) using the first client key (CK1) received from the device provisioning service 610, and the resulting plaintext configuration data 616 on the primary client device 606 provides the primary client device 606 with the session key (SK1) used by the primary client device 606 (and other client devices associated with the user ID) to submit an electronic transaction request to the transaction account service 608 for processing. In particular, the primary client device 606 can generate a plaintext transaction request comprising information regarding a requested electronic transaction (e.g., “cash-in,” $100), encrypt the plaintext transaction request using the session key (SK1) to generate an encrypted transaction system request (e.g., E_SK1("cash-in", $100)), and send (634) the encrypted transaction system request to the transaction account service 608 for transaction processing in association with the user ID (e.g., “JOHN”).

While various example embodiments are illustrated and described with respect to client devices (e.g., the primary client device 606) sending transaction requests to the transaction account service 608 for processing, some example embodiments support client devices sending non-transaction requests (e.g., service requests) in association with the user ID.

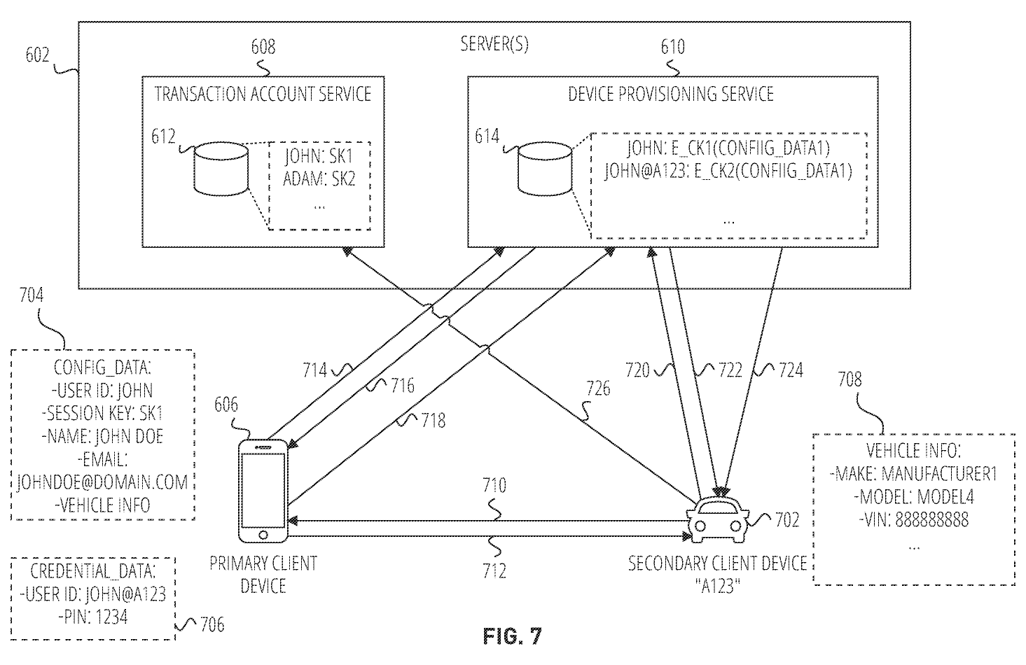

FIG. 7 is a diagram illustrating example interactions between one or more servers 602 of the system (e.g., the transaction system 114), the primary client device 606 after provisioning, and a secondary client device 702 during provisioning of the secondary client device 702, in accordance with some example embodiments of the present disclosure.

To start the provisioning process of the secondary client device 702, the secondary client device 702 gathers attribute information associated with the secondary client device 702 (e.g., where the secondary client device 702 is part of a vehicle, the attribute information can comprise vehicle information 708, such as a VIN, make of the vehicle, or a model of the vehicle). Additionally, the secondary client device 702 generates an ephemeral key pair comprising a private key and a public key, and sends provisioning request data 710 to the provisioned primary client device 606, where the provisioning request data 710 comprises the public key from the ephemeral key pair. The provisioning request data 710 can also comprise a unique device ID of the secondary client device 702 (e.g., “A123”), the gathered attribute information, or both. In response, the primary client device 606 generates a unique user ID (e.g., “JOHN@A123”) for the secondary client device based on the unique device ID (e.g., “A123”), generates plaintext device-specific credential data that comprises the unique user ID for the secondary client device and the PIN code (e.g., “1234”, which was registered with the device provisioning service 610 during the user registration process), encrypts the plaintext device-specific credential data 706 using the public key (from the provisioning request data 710) to generate encrypted device-specific credential data 712, and sends the encrypted device-specific credential data 712 to the secondary client device 702. The primary client device 606 registers (714) the unique user ID (e.g., “JOHN@A123”) and the PIN code with the device provisioning service 610 on behalf of the secondary client device 702 and obtains (716) a second client key (CK2) for the secondary client device 702. Additionally, the primary client device 606 adds the vehicle information 708 to the existing plaintext configuration data 616 (e.g., “config_data1”) to generate updated plaintext configuration data 704 for (e.g., on behalf of) the secondary client device 702, encrypts the updated plaintext configuration data 704 using the second client key (CK2) to generate (new) encrypted configuration data (e.g., E_CK2(config_data1)), and sends (e.g., uploads) (718) the encrypted configuration data to the device provisioning service 610. The device provisioning service 610, in turn, stores the encrypted configuration data (provided by the primary client device 606) in association with the unique user ID of the secondary client device 702 (e.g., "JOHN@A123:E_CK2(config_data1)) in the device provisioning data store 614.

Using the private key from the ephemeral key pair generated by the secondary client device 702, the secondary client device 702 decrypts the encrypted device-specific credential data 712 received from the primary client device 606 to generate a copy of the plaintext device-specific credential data 706 at the secondary client device 702. The secondary client device 702 then obtains, from the plaintext device-specific credential data, the unique user ID (e.g., “JOHN@A123”) and the PIN code (e.g., “1234”) that the primary client device 606 registered with the device provisioning service 610 on behalf of the secondary client device 702. Eventually, the secondary client device 702 sends (720) the unique user ID (e.g., “JOHN@A123”) and the PIN code (e.g., “1234”) (that was registered with the device provisioning service 610 by the primary client device 606) to the device provisioning service 610 in order to log into (e.g., sign in to) the device provisioning service 610 and to receive (722) the second client key (CK2) for the secondary client device 702 from the device provisioning service 610. Additionally, the device provisioning service 610 provides (724) the secondary client device 702 with a copy of the encrypted configuration data (e.g., E_CK2(config_data1)) that is stored on the device provisioning data store 614 in association with the unique user ID (e.g., “JOHN@A123”) and that that was sent (e.g., uploaded) by the primary client device 606 to the device provisioning service 610 earlier.

The secondary client device 702 decrypts the encrypted configuration data (e.g., E_CK2(config_data1)) using the second client key (CK2) for the secondary client device 702 received from the device provisioning service 610, and the resulting updated plaintext configuration data 704 on the secondary client device 702 provides the secondary client device 702 with the session key (SK1) used by the secondary client device 702 (and other client devices associated with the user ID) to submit an electronic transaction request to the transaction account service 608 for processing. In particular, the secondary client device 702 can generate a plaintext transaction request comprising information regarding a requested electronic transaction (e.g., “pay,” $20), encrypt the plaintext transaction request using the session key (SK1) to generate an encrypted transaction system request (e.g., E_SK1("pay", $20)), and send (726) the encrypted transaction system request to the transaction account service 608 for transaction processing in association with the user ID (e.g., “JOHN”).

While various example embodiments are illustrated and described with respect to client devices (e.g., the primary client device 606 and the secondary client device 702) sending transaction requests to the transaction account service 608 for processing, some example embodiments support client devices sending non-transaction requests (e.g., service requests) in association with the user ID.

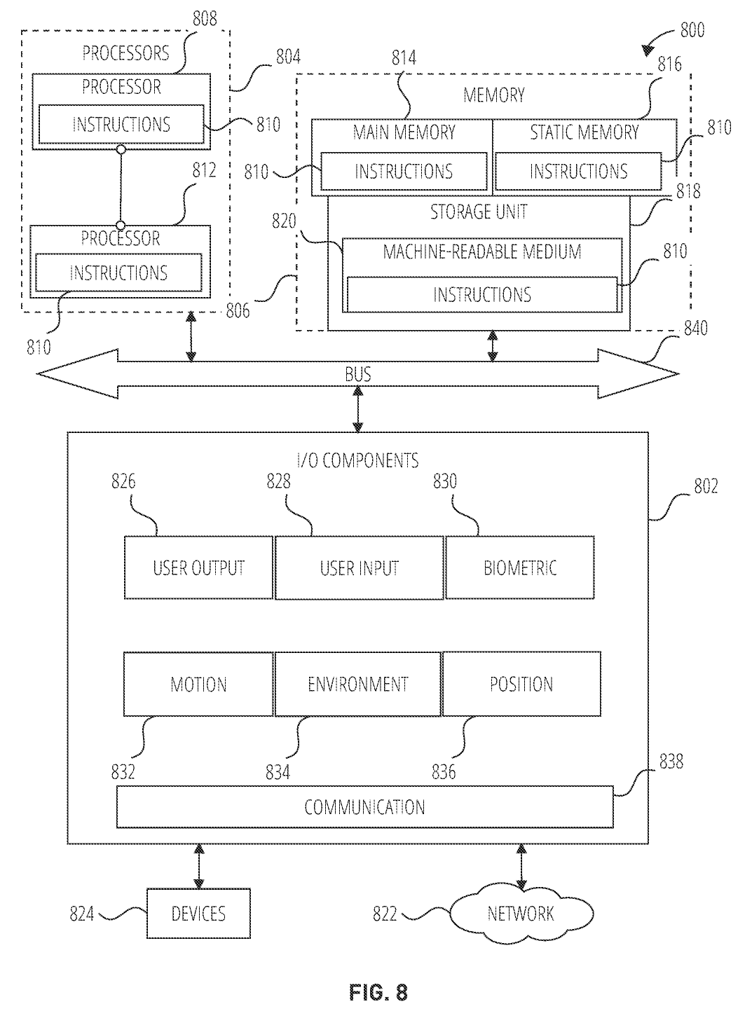

In some examples, components in the transaction system 114 can be a machine 800 as shown in FIG. 8. FIG. 8 is a diagrammatic representation of the machine 800 within which instructions 810 (e.g., software, a program, an application, an applet, an application, or other executable code) for causing the machine 800 to perform any one or more of the methodologies discussed herein may be executed. For example, the instructions 810 may cause the machine 800 to execute any one or more of the methods described herein. The instructions 810 transform the general, non-programmed machine 800 into a particular machine 800 programmed to carry out the described and illustrated functions in the manner described. The machine 800 may operate as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 810, sequentially or otherwise, that specify actions to be taken by the machine 800. Further, while only a single machine 800 is illustrated, the term “machine“ shall also be taken to include a collection of machines that individually or jointly execute the instructions 810 to perform any one or more of the methodologies discussed herein. The machine 800, for example, may comprise the client device 102 or any one of a number of server devices forming part of the transaction system 114. In some examples, the machine 800 may also comprise both client and server systems, with certain operations of a particular method or algorithm being performed on the server-side and with certain operations of the particular method or algorithm being performed on the client-side.

The machine 800 may include processors 804, memory 806, and input/output I/O components 802, which may be configured to communicate with each other via a bus 840. In an example, the processors 804 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 808 and a processor 812 that execute the instructions 810. The term "processor" is intended to include multi-core processors that may comprise two or more independent processors (sometimes referred to as “cores”) that may execute instructions contemporaneously. Although FIG. 8 shows multiple processors 804, the machine 800 may include a single processor with a single-core, a single processor with multiple cores (e.g., a multi-core processor), multiple processors with a single core, multiple processors with multiples cores, or any combination thereof.

The memory 806 includes a main memory 814, a static memory 816, and a storage unit 818, both accessible to the processors 804 via the bus 840. The main memory 814, the static memory 816, and storage unit 818 store the instructions 810 embodying any one or more of the methodologies or functions described herein. The instructions 810 may also reside, completely or partially, within the main memory 814, within the static memory 816, within machine-readable medium 820 within the storage unit 818, within at least one of the processors 804 (e.g., within the processor’s cache memory), or any suitable combination thereof, during execution thereof by the machine 800.

The I/O components 802 may include a wide variety of components to receive input, provide output, produce output, transmit information, exchange information, capture measurements, and so on. The specific I/O components 802 that are included in a particular machine will depend on the type of machine. For example, portable machines such as mobile phones may include a touch input device or other such input mechanisms, while a headless server machine will likely not include such a touch input device. It will be appreciated that the I/O components 802 may include many other components that are not shown in FIG. 8. In various examples, the I/O components 802 may include user output components 826 and user input components 828. The user output components 826 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 828 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 802 may include biometric components 830, motion components 832, environmental components 834, or position components 836, among a wide array of other components. For example, the biometric components 830 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 832 include acceleration sensor components (e.g., accelerometer), gravitation sensor components, rotation sensor components (e.g., gyroscope).

The environmental components 834 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the client device 102 may have a camera system comprising, for example, front cameras on a front surface of the client device 102 and rear cameras on a rear surface of the client device 102. The front cameras may, for example, be used to capture still images and video of a user of the client device 102 (e.g., “selfies”). The rear cameras may, for example, be used to capture still images and videos in a more traditional camera mode. In addition to front and rear cameras, the client device 102 may also include a 360° camera for capturing 360° photographs and videos.

Further, the camera system of a client device 102 may include dual rear cameras (e.g., a primary camera as well as a depth-sensing camera), or even triple, quad or penta rear camera configurations on the front and rear sides of the client device 102. These multiple cameras systems may include a wide camera, an ultra-wide camera, a telephoto camera, a macro camera and a depth sensor, for example.

The position components 836 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 802 further include communication components 838 operable to couple the machine 800 to a network 822 or devices 824 via respective coupling or connections. For example, the communication components 838 may include a network interface component or another suitable device to interface with the network 822. In further examples, the communication components 838 may include wired communication components, wireless communication components, cellular communication components, Near Field Communication (NFC) components, Bluetooth^{®} components (e.g., Bluetooth^{®} Low Energy), Wi-Fi^{®} components, and other communication components to provide communication via other modalities. The devices 824 may be another machine or any of a wide variety of peripheral devices (e.g., a peripheral device coupled via a USB).

Moreover, the communication components 838 may detect identifiers or include components operable to detect identifiers. For example, the communication components 838 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 838, such as location via Internet Protocol (IP) geolocation, location via Wi-Fi® signal triangulation, location via detecting an NFC beacon signal that may indicate a particular location, and so forth.

The various memories (e.g., main memory 814, static memory 816, and memory of the processors 804) and storage unit 818 may store one or more sets of instructions and data structures (e.g., software) embodying or used by any one or more of the methodologies or functions described herein. These instructions (e.g., the instructions 810), when executed by processors 804, cause various operations to implement the disclosed examples.

The instructions 810 may be transmitted or received over the network 822, using a transmission medium, via a network interface device (e.g., a network interface component included in the communication components 838) and using any one of several well-known transfer protocols (e.g., hypertext transfer protocol (HTTP)). Similarly, the instructions 810 may be transmitted or received using a transmission medium via a coupling (e.g., a peer-to-peer coupling) to the devices 824.

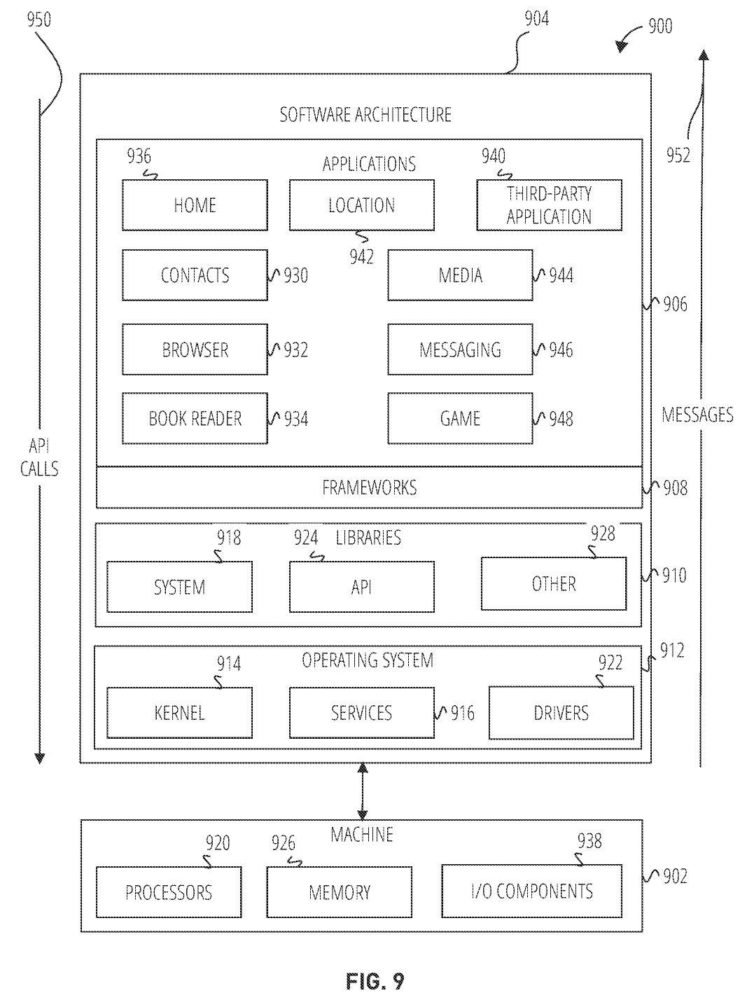

FIG. 9 is a block diagram 900 illustrating a software architecture 904, which can be installed on any one or more of the devices described herein. The software architecture 904 is supported by hardware such as a machine 902 that includes processors 920, memory 926, and I/O components 938. In this example, the software architecture 904 can be conceptualized as a stack of layers, where each layer provides a particular functionality. The software architecture 904 includes layers such as an operating system 912, libraries 910, frameworks 908, and applications 906. Operationally, the applications 906 invoke API calls 950 through the software stack and receive messages 952 in response to the API calls 950.

The operating system 912 manages hardware resources and provides common services. The operating system 912 includes, for example, a kernel 914, services 916, and drivers 922. The kernel 914 acts as an abstraction layer between the hardware and the other software layers. For example, the kernel 914 provides memory management, processor management (e.g., scheduling), component management, networking, and security settings, among other functionalities. The services 916 can provide other common services for the other software layers. The drivers 922 are responsible for controlling or interfacing with the underlying hardware. For instance, the drivers 922 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 910 provide a common low-level infrastructure used by the applications 906. The libraries 910 can include system libraries 918 (e.g., C standard library) that provide functions such as memory allocation functions, string manipulation functions, mathematic functions, and the like. In addition, the libraries 910 can include API libraries 924 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 910 can also include a wide variety of other libraries 928 to provide many other APIs to the applications 906.

The frameworks 908 provide a common high-level infrastructure that is used by the applications 906. For example, the frameworks 908 provide various graphical user interface (GUI) functions, high-level resource management, and high-level location services. The frameworks 908 can provide a broad spectrum of other APIs that can be used by the applications 906, some of which may be specific to a particular operating system or platform.

In an example, the applications 906 may include a home application 936, a contacts application 930, a browser application 932, a book reader application 934, a location application 942, a media application 944, a messaging application 946, a game application 948, and a broad assortment of other applications such as a third-party application 940. The applications 906 are programs that execute functions defined in the programs. Various programming languages can be employed to create one or more of the applications 906, structured in a variety of manners, such as object-oriented programming languages (e.g., Objective-C, Java, or C++) or procedural programming languages (e.g., C or assembly language). In a specific example, the third-party application 940 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 940 can invoke the API calls 950 provided by the operating system 912 to facilitate functionality described herein.

Described implementations of the subject matter can include one or more features, alone or in combination as illustrated below by way of examples.

Example 1 is a system comprising: a processor; and a memory storing instructions that, when executed by the processor, cause the system to perform operations comprising: receiving, at a transaction account service of the system, account setup data for a user from a current client device, the account setup data comprising a user identifier (ID) for the user and a password for the user; and generating, on the transaction account service, a session key in association with the user ID and a client key in association with the user ID, the session key being used to encrypt and authenticate one or more messages between one or more client devices associated with the user and the system, the client key being exclusively used by the one or more client devices for sharing information with the system.

In Example 2, the subject matter of Example 1 includes, wherein a Password-Authenticated Key Exchange (PAKE) protocol is used to generate the session key and the client key.

In Example 3, the subject matter of Examples 1–2 includes, wherein the operations comprise: receiving, at a device provisioning service of the system, provisioning login data from the current client device, the provisioning login data comprising the user ID and a personal identification number (PIN) code from the current client device; and in response to receiving the provisioning login data, providing the client key from the device provisioning service to the current client device.

In Example 4, the subject matter of Example 3 includes, wherein the operations comprise: providing the session key to the current client device; receiving encrypted configuration data from the current client device, the current client device being configured to generate the encrypted configuration data by encrypting plaintext configuration data using the client key provided to the current client device by the device provisioning service, the plaintext configuration data comprising at least one of the user ID, the session key, or profile information of the user; and storing the encrypted configuration data on the device provisioning service.

In Example 5, the subject matter of Example 4 includes, wherein the operations comprise: provisioning a primary client device in association with the user, the provisioning of the primary client device comprising: receiving, at the device provisioning service, the provisioning login data from the primary client device; and in response to receiving the provisioning login data from the primary client device, providing the client key from the device provisioning service to the primary client device.

In Example 6, the subject matter of Example 5 includes, wherein the provisioning of the primary client device comprises: providing the encrypted configuration data to the primary client device, the primary client device being configured to use the client key provided by the device provisioning service to decrypt the encrypted configuration data to generate a copy of the plaintext configuration data on the primary client device.

In Example 7, the subject matter of Example 6 includes, wherein the operations comprise: receiving, from the primary client device, an encrypted transaction request, the primary client device being configured to generate the encrypted transaction request by encrypting a plaintext transaction request using the session key retrieved from the copy of the plaintext configuration data on the primary client device, the plaintext transaction request comprising information regarding a transaction requested for the user by the primary client device.

In Example 8, the subject matter of Example 7 includes, wherein the operations comprise: in response to receiving the encrypted transaction request: using the session key to decrypt the encrypted transaction request to generate a copy of the plaintext transaction request; and processing the copy of the plaintext transaction request by the transaction account service.

Example 9 is a method to implement any of Examples 1–8.

Example 10 is at least one machine storage medium comprising instructions that, when executed by a processor, cause the processor to perform operations to implement any of Examples 1–8.

"Carrier signal" refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

"Client device" refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

"Communication network" refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

"Component" refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A "hardware component" is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase "hardware component"(or "hardware-implemented component") should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, "processor-implemented component" refers to a hardware component implemented using one or more processors. Similarly, the methods described herein may be at least partially processor-implemented, with a particular processor or processors being an example of hardware. For example, at least some of the operations of a method may be performed by one or more processors 804 or processor-implemented components. Moreover, the one or more processors may also operate to support performance of the relevant operations in a "cloud computing" environment or as a "software as a service" (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

"Computer-readable storage medium" refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

"Machine storage medium" refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms "machine-storage medium," "device-storage medium," "computer-storage medium" mean the same thing and may be used interchangeably in this disclosure. The terms "machine-storage media," "computer-storage media," and "device-storage media" specifically exclude carrier waves, modulated data signals, and other such media, at least some of which are covered under the term "signal medium."

"Non-transitory computer-readable storage medium" refers to a tangible medium that is capable of storing, encoding, or carrying the instructions for execution by a machine.

"Signal medium" refers to any intangible medium that is capable of storing, encoding, or carrying the instructions for execution by a machine and includes digital or analog communications signals or other intangible media to facilitate communication of software or data. The term "signal medium" shall be taken to include any form of a modulated data signal, carrier wave, and so forth. The term "modulated data signal" means a signal that has one or more of its characteristics set or changed in such a matter as to encode information in the signal. The terms "transmission medium" and "signal medium" mean the same thing and may be used interchangeably in this disclosure.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to some example embodiments, various modifications and changes may be made to these embodiments without departing from the broader scope of embodiments of the present disclosure.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The detailed description, therefore, is not to be taken in a limiting sense, and the scope of various example embodiments is defined only by the appended claims, along with the full range of equivalents to which such claims are entitled.

As used herein, the term “or” may be construed in either an inclusive or exclusive sense. The terms “a” or “an” should be read as meaning “at least one,” “one or more,” or the like. The use of words and phrases such as “one or more,” “at least,” “but not limited to,” or other like phrases shall not be read to mean that the narrower case is intended or required in instances where such broadening phrases may be absent.

Boundaries between various resources, operations, components, engines, and data stores are somewhat arbitrary, and particular operations are illustrated in a context of specific illustrative configurations. Other allocations of functionality are envisioned and may fall within a scope of various example embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The description above includes systems, methods, devices, instructions, and computer media (e.g., computing machine program products) that embody illustrative embodiments of the disclosure. In the description, for the purposes of explanation, numerous specific details are set forth in order to provide an understanding of various example embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

What is claimed is:

1. A system comprising:
a processor; and
a memory storing instructions that, when executed by the processor, cause the system to perform operations comprising:
receiving, at a transaction account service of the system, account setup data for a user from a current client device, the account setup data comprising a user identifier (ID) for the user and a password for the user; and
generating, on the transaction account service, a session key in association with the user ID and a client key in association with the user ID, the session key being used to encrypt and authenticate one or more messages between one or more client devices associated with the user and the system, the client key being exclusively used by the one or more client devices for sharing information with the system.

2. The system of claim 1, wherein a Password-Authenticated Key Exchange (PAKE) protocol is used to generate the session key and the client key.

3. The system of claim 1, wherein the operations comprise:
receiving, at a device provisioning service of the system, provisioning login data from the current client device, the provisioning login data comprising the user ID and a personal identification number (PIN) code from the current client device; and
in response to receiving the provisioning login data, providing the client key from the device provisioning service to the current client device.

4. The system of claim 3, wherein the operations comprise:
providing the session key to the current client device;
receiving encrypted configuration data from the current client device, the current client device being configured to generate the encrypted configuration data by encrypting plaintext configuration data using the client key provided to the current client device by the device provisioning service, the plaintext configuration data comprising at least one of the user ID, the session key, or profile information of the user; and
storing the encrypted configuration data on the device provisioning service.

5. The system of claim 4, wherein the operations comprise:
provisioning a primary client device in association with the user, the provisioning of the primary client device comprising:
receiving, at the device provisioning service, the provisioning login data from the primary client device; and
in response to receiving the provisioning login data from the primary client device, providing the client key from the device provisioning service to the primary client device.

6. The system of claim 5, wherein the provisioning of the primary client device comprises:
providing the encrypted configuration data to the primary client device, the primary client device being configured to use the client key provided by the device provisioning service to decrypt the encrypted configuration data to generate a copy of the plaintext configuration data on the primary client device.

7. The system of claim 6, wherein the operations comprise:
receiving, from the primary client device, an encrypted transaction request, the primary client device being configured to generate the encrypted transaction request by encrypting a plaintext transaction request using the session key retrieved from the copy of the plaintext configuration data on the primary client device, the plaintext transaction request comprising information regarding a transaction requested for the user by the primary client device.

8. The system of claim 7, wherein the operations comprise:
in response to receiving the encrypted transaction request:
using the session key to decrypt the encrypted transaction request to generate a copy of the plaintext transaction request; and
processing the copy of the plaintext transaction request by the transaction account service.

9. A machine storage medium including instructions that when executed by a processor, cause the processor to perform operations comprising:
using a primary client device to provision a secondary client device in association with a user, the primary client device being already provisioned in association with the user, the using of the primary client device to provision the secondary client device comprising:
generating, on the secondary client device, an ephemeral key pair that comprises a public key and a private key;
sending provisioning request data from the secondary client device to the primary client device, the provisioning request data comprising the public key from the ephemeral key pair, the provisioning request data comprising at least one of a unique device identifier (ID) of the secondary client device or attribute information associated with the secondary client device;
receiving, at the secondary client device, encrypted device-specific credential data from the primary client device, the primary client device being configured to generate the encrypted device-specific credential data by encrypting plaintext device-specific credential data using the public key provided to the primary client device by the secondary client device, the plaintext device-specific credential data comprising a unique user identifier (ID) for the secondary client device and a personal identification number (PIN) code; and
decrypting, on the secondary client device, the encrypted device-specific credential data using the private key from the ephemeral key pair to generate a copy of the plaintextdevice-specific credential data on the secondary client device.

10. The machine storage medium of claim 9, wherein the unique user ID is generated by the primary client device based on the unique device ID.

11. The machine storage medium of claim 9, wherein the primary client device is configured to:
send the plaintext device-specific credential data to a device provisioning service of a server; and
in response to sending the plaintext device-specific credential data to the device provisioning service, receive a client key for the secondary client device from the device provisioning service.

12. The machine storage medium of claim 9, wherein the operations comprise:
sending the plaintext device-specific credential data from the secondary client device to a device provisioning service of a server; and
in response to sending the plaintext device-specific credential data:
receiving, at the secondary client device from the device provisioning service, a client key for the secondary client device;
receiving, at the secondary client device from the device provisioning service, the encrypted configuration data; and
using the client key received from the device provisioning service to decrypt the encrypted configuration data to generate plaintext configuration data on the secondary client device, the plaintext configuration data comprising at least one of the user ID, a session key in association with the user ID, or profile information of the user.

13. The machine storage medium of claim 12, wherein the operations comprise:
generating, on the secondary client device, encrypted transaction request by encrypting a plaintext transaction request using the session key retrieved from the plaintext configuration data on the secondary client device; and
sending, from the secondary client device to a transaction account service of the server, the encrypted transaction request.

14. The machine storage medium of claim 13, wherein the transaction account service is configured to:
decrypt the encrypted transaction request using the session key to generate a copy of the plaintext transaction request; and
process the plaintext transaction request.

15. The machine storage medium of claim 9, wherein the secondary client device is associated with a vehicle, and wherein the attribute information comprises at least one of a vehicle identification number (VIN), a make of the vehicle, or a model of the vehicle.

16. A method comprising:
sending provisioning login data from a primary client device to a device provisioning service of a server, the provisioning login data comprising a user identifier (ID) of a user and a personal identification number (PIN) code;
in response to sending the provisioning login data to the device provisioning service, receiving, at the primary client device, a client key from the device provisioning service;
receiving, at the primary client device, encrypted configuration data from the device provisioning service; and
decrypting the encrypted configuration data to generate plaintext configuration data on the primary client device, the plaintext configuration data comprising at least one of the user ID, a session key, or profile information of the user.

17. The method of claim 16, comprising:
generating encrypted transaction request by encrypting a plaintext transaction request using the session key retrieved from the plaintext configuration data, the plaintext transaction request comprising information regarding a transaction requested for the user by the primary client device; and
sending, from the primary client device to a transaction account service of the server, the encrypted transaction request.

18. The method of claim 16, comprising:
receiving, at the primary client device, provisioning request data from a secondary client device, the provisioning request data comprising a public key from an ephemeral key pair generated on the secondary client device, the provisioning request data comprising at least one of a unique device identifier (ID) of the secondary client device or attribute information associated with the secondary client device;
generating, at the primary client device, encrypted device-specific credential data by encrypting plaintext device-specific credential data using the public key from the provisioning request data, the plaintext device-specific credential data comprising a unique user identifier (ID) for the secondary client device and the PIN code; and
sending, from the primary client device to the secondary client device, the encrypted device-specific credential data.

19. The method of claim 18, comprising:
generating, at the primary client device, the unique user ID based on the unique device ID from the provisioning request data.

20. The method of claim 18, wherein the client key is a first client key, and wherein the method comprises:
sending, from the primary client device, the plaintext device-specific credential data to the device provisioning service; and
in response to sending the plaintext device-specific credential data to the device provisioning service, receiving, at the primary client device, a second client key for the secondary client device from the device provisioning service.
